(19) United States
(12) Patent Application Publication
(10) Pub. No.: US 2023/0315082 A1
(43) Pub. Date: Oct. 5, 2023

(54) PREDICTIVE MAINTENANCE METHOD AND SYSTEM

(71) Applicants: VITESCO TECHNOLOGIES GMBH, Regensburg (DE); CONTINENTAL AUTOMOTIVE GMBH, Hanovre (DE)

(72) Inventors: Dominique-Jean MARTINEAU, Toulouse (FR); Olivier MANNS, Toulouse (FR); Nicolas TERRAL, Toulouse (FR)

(21) Appl. No.: 18/016,337

(22) PCT Filed: Jun. 16, 2021
(86) PCT No.: PCT/EP2021/066256

§ 371 Date: Jan. 14, 2023

(30) Foreign Application Priority Data
Jul. 15, 2020 (FR) FR2007414

(51) Int. Cl. G05B 23/02; G07C 5/08

(52) U.S. Cl. CPC G05B 23/0283; G05B 23/024; G07C 5/0808; G07C 5/0825

(57) ABSTRACT

The present invention relates to a method for predictive maintenance of a component (11) of a road vehicle (10) and a predictive maintenance device configured to implement said method. The method is implemented by at least one calculator (12) connected to the component (11) and comprises the following steps:
a. collecting a data set of the vehicle (S200) comprising:
i. first data relating to the use of first predetermined combinations of usage parameters of said component (CP1(1), . . . , CP1(N)),
ii. second data relating to the use of second predetermined combinations of usage parameters of said vehicle (CP2(1), . . . , CP2(M)),
iii. third data for establishing the course of at least one control parameter of the component representative of wear of the component (P3) as a function of the number of kilometers traveled by the vehicle,
b. as a function of the first and second data of the vehicle, selecting (S300), from a plurality of pre-established classes of vehicles (C1,1, . . . , C5,5) having similar first data and second data, a class for which the first data and second data of the vehicle are similar to those of the vehicles of the class selected,
c. comparing the third data of the vehicle with reference data of the class selected (S400), the reference data being obtained from data on the course of said control parameter representative of wear of the component of each of the vehicles of the class selected,
d. deducing, according to the result of the comparison, a future behavior of the component (S500).

### TECHNICAL FIELD

The present disclosure relates to the field of predictive maintenance for components of road vehicle.

### PRIOR ART

Preventive maintenance of a road vehicle consists in performing scheduled maintenance so that a component can be replaced before it fails. Maintenance operations are generally scheduled according to component operating times, generally expressed in number of operating hours, calculated to allow for replacement of the part before it fails.

This method is not very efficient because it is based on nominal values established for a set of components and does not take the real state of the component into account. Thus, components are systematically replaced while some of them could still be used.

Moreover, in case of a sudden failure of the component's performance, the user can only notice failure of their component, without having been alerted of the component degradation.

Document US20180204393A1 proposes to predict a time of use or a distance that can be traveled by the vehicle before a maintenance operation of a component, such as an air filter, is necessary. This prediction is implemented when mean values and/or standard deviation of collected data representative of filter fouling are above thresholds. The prediction is based on a variation in the mean value and/or standard deviation of data representative of filter fouling. These thresholds can be predetermined or estimated according to parameters such as the distance traveled by the vehicle, a driving history of the vehicle, a calibration value obtained upon installing the filter for example.

This method has a drawback. Data that are acquired concerning filter fouling are not necessarily correlated to a context of use of the component, in addition to a context of use of the vehicle, which does not allow to have a great accuracy in the detection and in the prediction made.

### SUMMARY

The present disclosure improves this situation.

In particular, one purpose of the present disclosure is to predict future behavior, such as future failure, of the component with a better reliability.

There is provided a method for predictive maintenance of a component of a road vehicle, the method being implemented by at least one calculator connected to the component, the method comprising the following steps:
a. collecting a data set of the vehicle including:
i. first data relating to the use of first predetermined combinations of usage parameters of said component,
ii. second data relating to the use of second predetermined combinations of usage parameters of said vehicle,
iii. third data for establishing the course of at least one control parameter of the component representative of wear of the component as a function of the number of kilometers traveled by the vehicle,
b. as a function of the first and second data of the vehicle, selecting, from a plurality of pre-established classes of vehicles having similar first data and second data, a class for which the first data and second data of the vehicle are similar to those of the vehicles of the class selected,
c. comparing the third data of the vehicle with reference data of the class selected, the reference data being obtained from data on the course of said control parameter representative of wear of the component of each of the vehicles of the class selected,
d. deducing, based on the result of the comparison, a future behavior of the component.

According to another aspect, there is provided a device for predictive maintenance of at least one component of a road vehicle, the device comprising:
at least one calculator connected to the component comprising a processor and a memory storing:
a plurality of pre-established classes of vehicles having first data relating to the use of first predetermined combinations of usage parameters of the component and second data relating to the use of second predetermined combinations of similar usage parameters of the vehicle for vehicles belonging to the same class, and
reference data associated with each class, the reference data being obtained from data on the course of said control parameter representative of wear of the component of each of the vehicles of the class considered, the at least one calculator being configured to:
a. collect a data set of said vehicle comprising:
i. first data relating to the use of first predetermined combinations of usage parameters of said component,
ii. second data relating to the use of second predetermined combinations of usage parameters of said vehicle,
iii. third data for establishing the course of at least one control parameter of the component representative of wear of the component as a function of the number of kilometers traveled by the vehicle,
b. as a function of the first and second data of said vehicle, select, from the plurality of pre-established classes stored in the memory, a class for which the first data and the second data of said vehicle are similar to those of the vehicles of the class selected,
c. compare third data of the vehicle with the reference data of the class selected stored in the memory,
d. deduce, based on the result of the comparison, a future behavior of the component.

According to another aspect, there is provided a computer program comprising instructions for implementing all or part of a method as defined herein when such program is executed by a processor. According to another aspect, there is provided a non-transitory, computer-readable recording medium on which such a program is recorded.

Characteristics set out in the following paragraphs can optionally be implemented. They can be implemented independently of each other or in combination with each other:
the method further comprises, at the end of the comparison step, a step of detecting an abnormal behavior of the component with respect to the components of the vehicles of the class selected and the step of deducing a future behavior of the component is a step of deducing a future failure of the component;
the reference data of the class selected comprise dispersion data of the control parameter around a mean value obtained for all vehicles of the class selected, and the comparison step includes comparing the values of the control parameter of said vehicle for a number of kilometers traveled with the corresponding dispersion data;
the method further comprises issuing an alert message when abnormal behavior of a vehicle component is detected at the end of the comparison step;
the first data comprises a plurality of frequencies of use of each predetermined combination of usage parameters of the component and the second data comprises a plurality of frequencies of use of each predetermined combination of usage parameters of said vehicle;
the plurality of pre-established classes is obtained by implementing an unsupervised classification algorithm from the first and second data collected for a plurality of vehicles;
the step of collecting a data set of the vehicle further comprises collecting fourth data relating to the number of kilometers traveled by the vehicle, and the step of selecting a class of vehicles comprises:
selecting a plurality of pre-established classes from a set of pre-established classes based on the number of kilometers traveled by the vehicle, and
selecting one class from the plurality of classes based on the first and second data of said vehicle;
the calculator is configured to detect, at the end of the comparison, an abnormal behavior of the component with respect to the components of the vehicles of the class selected and to deduce a future failure of the component therefrom.

### BRIEF DESCRIPTION OF THE DRAWINGS

Further characteristics, details and advantages will become apparent from the detailed description below, and from an analysis of the appended drawings, in which:

FIG. 1 represents a predictive maintenance system according to one embodiment.

FIG. 2 represents a predictive maintenance method according to one embodiment.

FIG. 3A represents a first data set collected by a vehicle according to one embodiment.

FIG. 3B represents a second data set collected by a vehicle according to one embodiment.

FIG. 3C represents a third data set collected by a vehicle according to one embodiment.

FIG. 4 illustrates a combination of vehicle usage parameters.

FIG. 5 represents a set of classes used by the method of FIG. 2.

FIG. 6 represents the course of a control parameter for a class selected and for the vehicle concerned.

### DESCRIPTION OF THE EMBODIMENTS

The following drawings and description essentially contain definite elements. Therefore, they may not only serve to further the understanding of the present disclosure, but also contribute to its definition, where applicable.

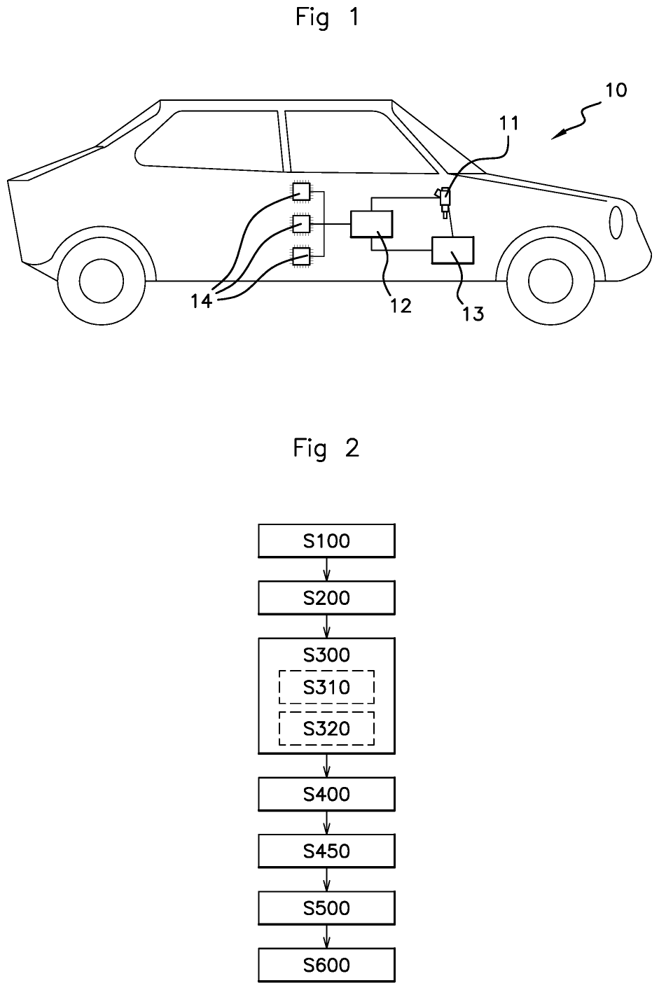

FIG. 1 illustrates a predictive maintenance system adapted to implement the predictive maintenance method of FIG. 2 according to one embodiment. The predictive maintenance system includes a predictive maintenance device installed in a road vehicle 10, here a car, and a remote server 20 able to communicate with the predictive maintenance device installed in the vehicle. By road vehicle, it is meant any vehicle with an engine or motor (usually internal combustion engine or electric motor) designed to move it on the road and capable of transporting people or loads.

The vehicle 10 comprises at least one component 11, at least one calculator 12, at least one electronic controller 13 of the component and a plurality of sensors 14. The calculator 12 is connected to the component 11, the electronic controller 13 and the plurality of sensors 14, for example, via a Controller Area Network (CAN) or FlexRAy type data communication bus. The calculator 12 can be configured to communicate directly with the remote server 20, when the calculator 12 includes adapted communication interfaces, or indirectly, via another calculator including adapted communication interfaces. In this case, data is transmitted between the two separate calculators via the aforementioned data communication bus. it will be noted that the electronic controller 13 of the component may be separate (as shown here) or may be integrated into the calculator 12.

In the example described here, the calculator 12 is an engine controller (electronic control unit) and comprises at least one processor, a memory and communication interfaces with various actuators and sensors of the vehicle and more particularly of the engine or motor as well as communication interfaces with the remote server 20. The electronic controller 13 of the component 12 is configured to implement a predetermined control law as a function of different parameters measured by different sensors specific but not limited to the component. The electronic controller 13 also comprises at least one processor, a memory and communication interfaces with the various sensors if necessary.

In addition, the electronic controller 13, upon controlling the component 11, obtains a measurement of a parameter involved in the control law and representative of wear of the component, also called the control parameter of the component. This value is advantageously periodically collected by the calculator 12 in order to know the course of the wear parameter of the component as a function of the number of kilometers traveled.

Some of the sensors 14 make it possible to acquire physical characteristics describing the dynamic behavior of the vehicle 10. In one exemplary embodiment, the sensors 14 allow acquisition of usage parameters of the vehicle such as speed, engine (or motor) torque, engine temperature, accelerator pedal position, vehicle acceleration or deceleration, steering wheel angle or steering angle for example.

Another part of the sensors 14 can be used to obtain usage parameters of the component considered. Advantageously, the usage parameters of the component are parameters having an influence on wear of the component. The usage parameters of the component can also be obtained by means of the electronic controller 13 when the latter is distinct from the calculator 12 and by means of the calculator 12, in this case the engine controller. These may include, for example, in the case of an automobile vehicle fuel injector, parameters such as fuel injection pressure, fuel temperature, fuel injection quantity and injection pump speed. Of course, other types of components and therefore other component usage parameters can be considered.

An odometer may also be included among the sensors 14 in order to determine the number of kilometers traveled by the vehicle.

The calculator 12 is configured to collect data relating to the use of the vehicle, the usage of the component and the course of wear of the component as a function of the number of kilometers traveled.

In particular, data relating to the vehicle usage and component usage may correspond to data relating to the use of predetermined combinations of component usage and vehicle usage parameters, respectively.

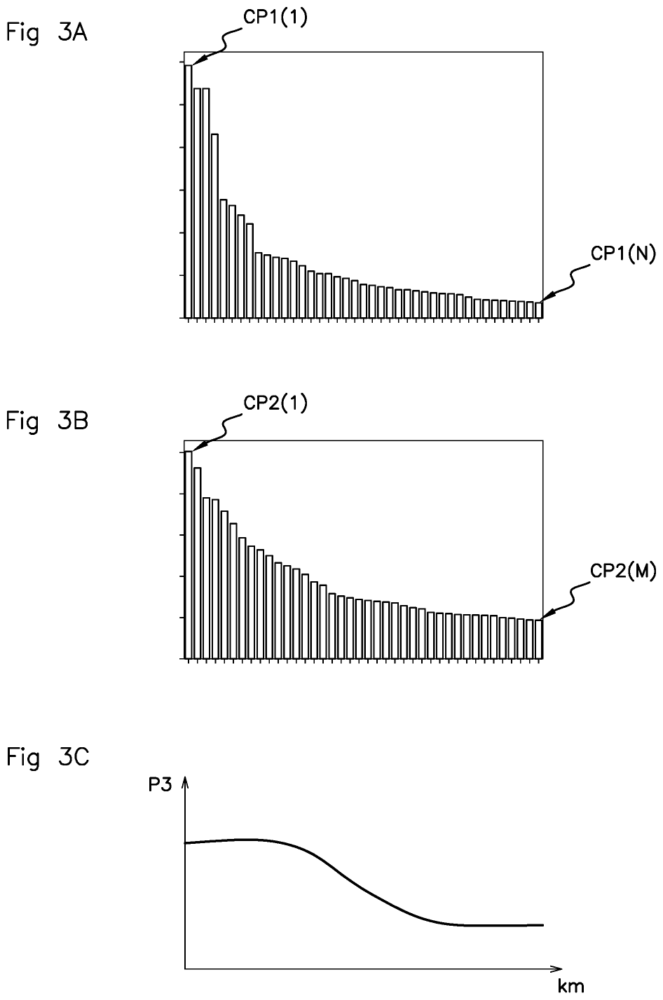

The collected data relating to the component usage may comprise frequencies of use of predetermined combinations of usage parameters of the component. As illustrated in FIG. 3A, for each predetermined combination of component usage parameters CP1(1), . . . , CP1(N), the calculator 12 counts the number of times a particular combination of usage parameters of the component has been used in a manner similar to what is described in the part p.7, I.10 to p.8, I.17 of the patent application filed under number FR1900865 on behalf of the applicant in the case of wear parameters of a fuel injector.

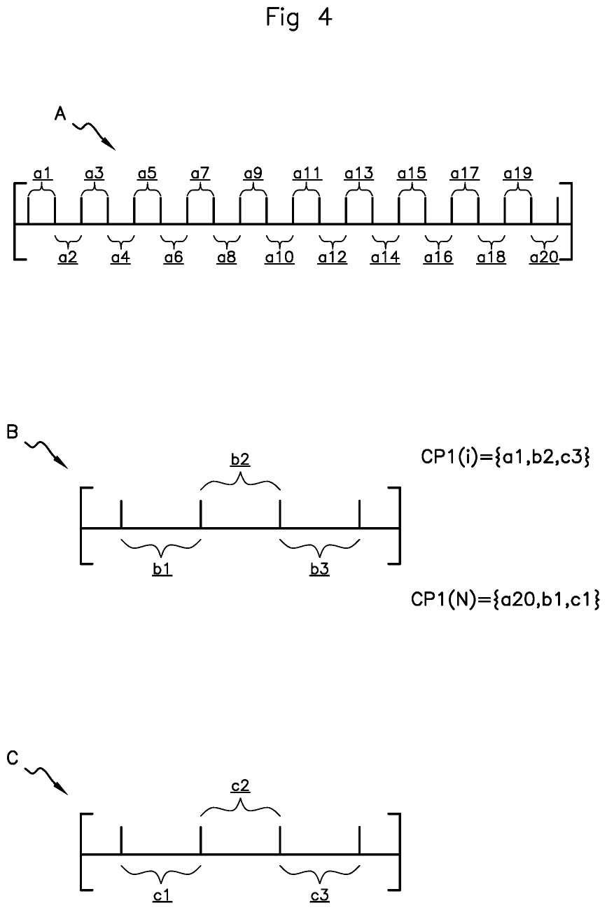

Advantageously, as illustrated in FIG. 4, each usage parameter, A, B, C of the component for example, is divided into a plurality of ranges of values {a1, . . . , a20}, {b1, . . . , b3}, {c1, . . . , c3}, respectively. Each predetermined combination CP1(1), . . . , CP1(N) of usage parameters of the component corresponds to a particular combination of one or more ranges of values of each of the parameters A, B, C, of usage of the component for example CP1(1)={a1, a2; b2; c3}, . . . , CP1(N)={a20; b1; c1}. The data collected in this way allows establishment of a usage profile of the component for the vehicle considered.

The collected data related to the vehicle usage may comprise frequencies of use of predetermined combinations of usage parameters of the vehicle. As illustrated in FIG. 3B, for each predetermined combination of usage parameters of the vehicle CP2(1), . . . , CP2(N), the calculator 12 counts the number of times a particular combination of usage parameters of the vehicle has been used. It will be noted that the combinations of usage parameters of the vehicle are defined in a similar way to what was described with reference to FIG. 4. These are combinations of ranges of values of the different usage parameters of the vehicle. The data collected in this way allows establishment of a usage profile for the vehicle concerned.

Furthermore, the data relating to the course of wear of the component correspond to data relating to the course of at least one wear parameter P3 of the component as a function of the number of kilometers traveled as schematically illustrated with reference to FIG. 3C. In the case of a fuel injector, this may be, for example, the injector closing time which is representative of wear of the injector needle.

As is visible in FIG. 3C, the wear parameter of the component, i.e. the control parameter representative of wear of the component, changes as a function of the number of kilometers traveled. The course of the wear parameter is correlated to the way the vehicle and the component are used and thus to the usage profiles of the vehicle and of the component.

Furthermore, as mentioned previously, the predictive maintenance device comprising the calculator 12 is able to communicate with the remote server 20. The remote server 20 is configured to collect, for a plurality of vehicles, data relating to the usage of the vehicle, the usage of the component and the course of wear of the component as a function of the number of kilometers traveled such as those previously described with reference to FIGS. 3A, 3B and 3C for example. In particular, the data set collected by the remote server 20 corresponds to data collected and transmitted by a plurality of vehicles similar to the vehicle 10 described with reference to FIG. 1, and comprising a calculator 12 connected to a component 11, an electronic controller 13 and to a plurality of sensors 14.

The remote server 20 is also configured to determine a plurality of classes through implementation of an unsupervised classification algorithm, based on component usage and vehicle usage data collected as described above for a plurality of vehicles. The implementation of the unsupervised classification algorithm makes it possible to identify vehicles with similar component usage and vehicle usage profiles. The vehicle usage and component usage profiles are associated with the distribution of frequencies of use of different combinations CP1(1), . . . , CP1(N) and CP2(1), . . . , CP2(M) of component usage and vehicle usage parameters, respectively. The unsupervised classification can thus be done based on the frequencies of use of the combinations of component wear and vehicle wear parameters collected for each vehicle, for example.

The remote server 20 is also configured to determine reference data associated with each of the classes. The reference data relate to the course of the wear parameter of the component as a function of the number of kilometers traveled and are obtained from data on the course of the wear parameter of the component of each of the vehicles of one class.

Finally, the remote server 20 is configured to transmit, to the vehicle predictive maintenance device, data regarding the pre-established classes and associated reference data to be stored in the memory of the calculator 12.

Thus, the calculator 12 is able, from the data collected by the vehicle, i.e. data relating to the usage of the vehicle, the usage of the component and the course of wear of the component, and from the data relating to the plurality of pre-established classes stored in its memory, including the reference data associated with each of the pre-established classes, to deduce a future behavior of the component as described in more detail with reference to FIG. 2. Regarding the future behavior of the component, it can be a future failure of the component, when it shows an abnormal behavior in terms of wear with respect to the vehicles of its class or to predict the value of the wear parameter of the component for example.

In one embodiment, the vehicle 10 may also include a display (not represented) connected to the calculator 12 for displaying an alert message to the driver or a dedicated maintenance service, for example when the behavior of the component is abnormal in terms of wear with respect to wear data collected for vehicles with similar usage parameters of the component and the vehicle, in order to indicate that maintenance of this component is to be scheduled.

FIG. 2 describes in more detail the steps of the predictive maintenance method implemented by the calculator 12 of the predictive maintenance device.

With reference to what has been previously described, the predictive maintenance method includes a step S100 of receiving and storing in memory data concerning the classes pre-established by the remote server 20 and reference data associated with each class.

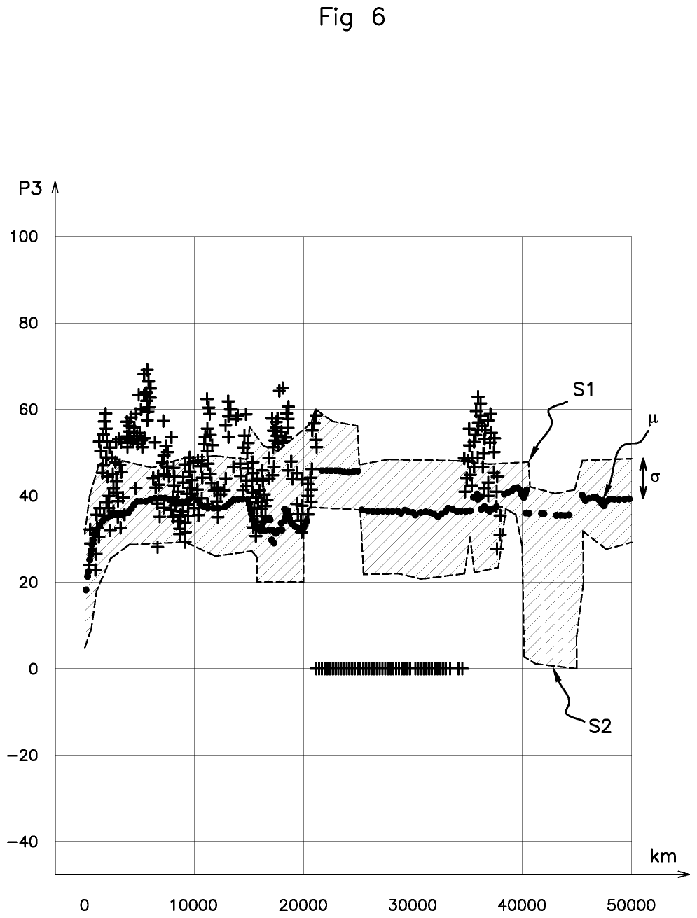

The data concerning the pre-established classes allow identification of vehicles with similar component usage and vehicle usage profiles, and the reference data are obtained from the data on the course of the component wear parameter for each of the vehicles in the class considered. This reference data can be obtained by a statistical analysis of the course data collected for each of the vehicles of the class considered. Thus, the reference data may include, for example, positional characteristics (for example, mode, median, arithmetic mean, quantiles) and dispersion characteristics (for example, range, mean deviation, interquartile deviation, variance, standard deviation, and coefficient of variation). In the example of FIG. 6, the mean value μ and the standard deviation σ are represented as a function of the number of kilometers traveled for a particular class of vehicles.

The predictive maintenance method also includes a step S200 of collecting data relating to the usage of the vehicle, data relating to the usage of the component and data relating to the course of wear of the component as a function of the number of kilometers traveled as described previously with reference to FIGS. 3A, 3B and 3C for example. It is reminded here that the data relating to the usage of the vehicle and the usage of the component make it possible to establish a usage profile of the component and a usage profile of the vehicle, that is a distribution of the frequencies of use of the different combinations of usage parameters of the vehicle and of the component.

In particular, the number of times each predetermined combination CP2(1), . . . , CP2(M) of usage parameters of the vehicle and the number of times each predetermined combination CP1(1), . . . , CP1(N) of usage parameters of the component is used are collected. This can be made by incrementing a counter, specific to each combination of parameters, each time each of the usage parameters of the component or the vehicle belongs to a range of values of the combination considered. The course of the wear parameter, i.e. the control parameter representative of wear, is also collected as a function of the number of kilometers traveled. In one embodiment, in order to reduce the volume of data collected, a mean value of the wear parameter obtained over a predetermined distance traveled, for example, every 100 km, can be collected.

The predictive maintenance method also includes a step S300 of selecting, from the plurality of pre-established classes stored in memory, a class for which the data relating to component usage and the data relating to vehicle usage collected in step S200 are similar to those of the vehicles of the class selected.

More precisely, the selection is made so as to select a class for which the vehicle usage and component usage profiles are similar using data concerning the distribution of frequency of use of different combinations of component usage parameters CP1 and different combinations of vehicle usage parameters CP2 and data concerning the pre-established classes stored in memory. For example, the data concerning the pre-established classes may correspond to the position of a centroid for each pre-established class and the class with its closest centroid is selected.

Then, in a step S400, the data relating to the course of the vehicle wear parameter collected in step S200 and the reference data associated with the class selected in step S300 are compared.

In one exemplary embodiment, each value of the wear parameter collected in step S200 is compared to one or more threshold values defined based on reference data for the class considered. The threshold values S1 and S2 can be determined from position and/or dispersion characteristics previously described, for example.

In the example of FIG. 6, it is checked whether a value of the wear parameter collected for the vehicle, represented by a cross in the figure, is:
higher than a first threshold value S1 corresponding to μ+σ, or
lower than a second threshold value S2 corresponding to μ−σ,
   μ being the mean value and σ the standard deviation, over all the vehicles belonging to the class, of the wear parameter P3 of the component for a given number of kilometers traveled.

It is reminded that in the case of a fuel injector, the wear parameter, i.e. the control parameter representative of the component wear, can correspond to the injector closing time for example.

Alternatively or additionally, step S400 can include a sub-step of calculating a sliding average from the data relating to the course of wear of the component collected during step S200, here the mean value of the wear parameter collected every 100 km, and a sub-step of comparing the value of the sliding average with the average μ.

Next, in a step S450, it is determined whether the behavior of the vehicle component 10 is abnormal relative to components of vehicles of the class selected. For example, abnormal behavior of the component is detected when the number of times a representative value of the collected wear parameter is outside a reference range. In the example of FIG. 6, the reference range is defined by the two threshold values S1 and S2 previously described. It will be noted that the reference range, and therefore the threshold values S1, S2, can vary as a function of the number of kilometers traveled as represented by the dotted curves in FIG. 6.

Then, during a step S500, a future behavior of the component is deduced therefrom.

In one embodiment, when abnormal behavior is detected in step S450, a future failure of the component is deduced therefrom. In step S600, an alert message is then issued to the driver or to a maintenance service in order to indicate that maintenance of this component is to be scheduled.

Step S200 can be implemented continuously, while steps S300, S400, S450 and S500 can be periodically implemented, depending on the number of kilometers traveled by the vehicle.

Step S200 of collecting a data set of the vehicle may thus further comprise collecting data relating to the number of kilometers traveled by the vehicle and step S300, as well as the successive steps, is implemented when a predetermined number of kilometers has been traveled by the vehicle for example when the number of kilometers traveled by the vehicle since the last iteration of these steps is a number less than 10,000 km for example.

Furthermore, in one embodiment, the step S300 of selecting a class from the plurality of classes pre-established by the remote server 20 and stored in memory can comprise:
a first sub-step S310 of selecting a plurality of pre-established classes from a set of pre-established classes as a function of the number of kilometers traveled by the vehicle 10 determined in step S200, and
a second sub-step S320 of selecting a class from the plurality of classes selected in sub-step S310.

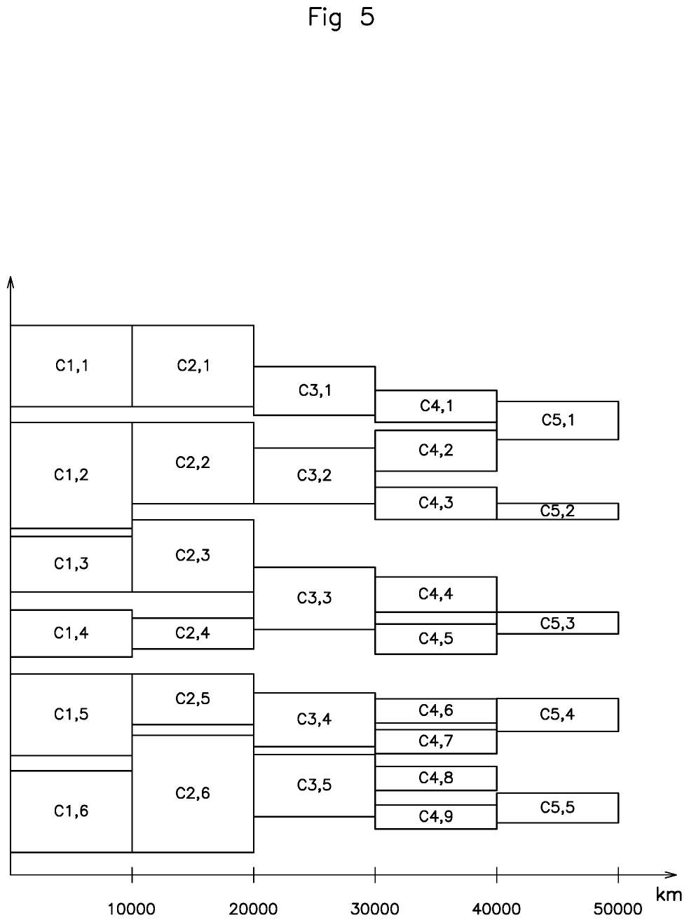

Indeed, as illustrated with reference to FIG. 5, the set of classes pre-established by the remote server 20 and stored in memory in the electronic maintenance device may comprise a plurality of subclasses, each subclass being established for a predefined range of kilometers traveled.

In the example of FIG. 5, subclasses C1,1, C1,2, C1,3, C1,4, C1,5, C1,6 are established for vehicles having run between 0 and 10 000 km;
subclasses C2,1, C2,2, C2,3, C2,4, C2,5, C2,6 are established for vehicles having run between 0 and 20,000 km;
subclasses C3,1, C3,2, C3,3, C3,4, C3,5, are established for vehicles having run between 0 and 30 000 km;
subclasses C4,1, C4,2, C4,3, C4,4, C4,5, C4,6, C4,7, C4,8, C4,9 are established for vehicles having run between 0 and 40,000 km;
subclasses C5,1, C5,2, C5,3, C5,4, C5,5, are established for vehicles having run between 0 and 50,000 km.

Each subclass gathers vehicles with similar vehicle and component usage profiles for the predetermined range of kilometers traveled. Likewise, the reference data associated with these subclasses are calculated for the corresponding ranges of kilometers traveled.

In the example of FIG. 5, a vehicle that has traveled a distance of 35,000 km upon implementing step S300 will be assigned a class selected from the group of subclasses C4,1, C4,2, C4,3, C4,4, C4,5, C4,6, C4,7, C4,8, C4,9.

Thus, dividing the set of pre-established classes into different groups of subclasses according to the number of kilometers traveled by the vehicles allows the unsupervised classification algorithm to be implemented based on the currently available data. This is particularly advantageous when not all the vehicles used to collect the data have traveled long distances. It is then possible to obtain reference data for different ranges of kilometers traveled, with the reference data being more accurate for the first ranges of kilometers traveled. This is because a greater number of vehicles have traveled in the first ranges of kilometers, as illustrated in FIG. 5 by the width of the boxes symbolizing the number of vehicles in each subclass.

Advantageously, the step S100 of receiving and storing in memory data concerning the pre-established classes and the reference data associated with each class can be regularly updated, in particular in order to refine the model, i.e. the classes and the associated reference data, when the number of kilometers traveled by the different vehicles increases.

Furthermore, it will be noted that the data collected by the calculator 12 can also be transmitted to the remote server in order to be taken into account by the unsupervised classification algorithm for the establishment of classes and for the calculation of the reference data associated with these classes. The establishment of the classes then includes a sub-step of selecting the data set collected by the different vehicles as a function of the number of kilometers traveled. Thus, the collected data used by the remote server 20 are advantageously transmitted when a predetermined number of kilometers has been traveled by each vehicle. In the example described here, every 10,000 km for example.

In one alternative embodiment, in step S450, if no abnormal behavior of the component is detected, it is deduced therefrom that the component behaves like all components of the class selected and, in step S500, a future behavior of the component can be deduced therefrom by predicting the value of the wear parameter of the component after the vehicle has traveled a determined additional distance. In particular, the value of at least one wear parameter of the component, for predetermined kilometers traveled, can be predicted using reference data obtained for a subclass established for a range of kilometers traveled comprising the predetermined kilometers traveled.

Advantageously, the subclass considered is selected so that it includes a majority of vehicles with a similar vehicle wear profile and component wear profile as the vehicle considered for the number of kilometers currently traveled by the vehicle upon implementing step S300. Step S100 may then include receiving and storing in memory data regarding the subclasses, and more particularly the reference data associated, to be used for predicting the value of the wear parameter at the predetermined kilometers traveled as a function of the subclass selected in step S320. For example, according to the previous example, if subclass C4,3 has been selected in step S320 and the value of the wear parameter is to be predicted for a distance of 100,000 km, subclass C4,3 will be associated with subclass C10,k established for vehicles that have been run between 0 and 100,000 km for which the maximum number of vehicles in subclass C4,3 have a vehicle usage and component usage profile similar to vehicles in class C10,k.

It is then possible, using the at least one wear parameter, to deduce therefrom an end-of-life time for the component, for example.

What is claimed is:

1. A method for predictive maintenance of a component (11) of a road vehicle (10), the method being implemented by at least one calculator (12) connected to the component (11), the method comprising the following steps:
a. collecting a data set of the vehicle (S200) including:
i. first data relating to the use of first predetermined combinations of usage parameters of said component (CP1(1), . . . , CP1(N)),
ii. second data relating to the use of second predetermined combinations of usage parameters of said vehicle (CP2(1), . . . , CP2(M)),
iii. third data for establishing the course of at least one control parameter of the component representative of wear of the component (P3) as a function of the number of kilometers traveled by the vehicle,
b. based on the first and second data of the vehicle, selecting (S300), from a plurality of pre-established classes of vehicles (C1,1, . . . , C5,5) having similar first data and second data, a class for which the first data and second data of the vehicle are similar to those of the vehicles of the class selected,
c. comparing the third data of the vehicle with reference data of the class selected (S400), the reference data being obtained from data on the course of said control parameter representative of wear of the component of each of the vehicles of the class selected,
d. deducing, according to the result of the comparison, a future behavior of the component (S500).

2. The method (100) for predictive maintenance of a component (11) according to claim 1, wherein:
the method further comprises, at the end of the comparison step, a step of detecting (S450) an abnormal behavior of the component with respect to the components of the vehicles of the class selected, and
the step of deducing a future behavior of the component (S500) is a step of deducing a future failure of the component.

3. The method for predictive maintenance of a component (11) according to claim 1, wherein:
the reference data of the class selected comprise dispersion data of the control parameter around a mean value obtained for all the vehicles of the class selected, and
the comparison step (S400) comprises comparing the values of the control parameter of said vehicle for a number of kilometers traveled with the corresponding dispersion data.

4. The method for predictive maintenance of a component (11) according claim 1, wherein the method further comprises issuing an alert message (S600) when abnormal behavior of a component of a vehicle is detected at the end of the comparison step.

5. The method for predictive maintenance of a component (11) according to claim 1, wherein:
the first data comprise a plurality of frequencies of use of each predetermined combination of usage parameters of the component;
the second data comprise a plurality of frequencies of use of each predetermined combination of usage parameters of said vehicle.

6. The method for predictive maintenance of a component (11) according to claim 1, wherein:
the plurality of pre-established classes is obtained by implementing an unsupervised classification algorithm from the first and second data collected for a plurality of vehicles.

7. The method for predictive maintenance of a component (11) according to claim 1, wherein:
the step of collecting a data set of the vehicle (S200) further comprises collecting fourth data relating to the number of kilometers traveled by the vehicle,
the step of selecting (S300) a class of vehicles comprises:
selecting a plurality of pre-established classes from a set of pre-established classes based on the number of kilometers traveled by the vehicle (S310), and
selecting one class from the plurality of classes based on the first and second data of said vehicle (S320).

8. A device for predictive maintenance of at least one component (11) of a road vehicle (10), the device comprising:
at least one calculator (12) connected to the component (11) comprising a processor and a memory storing:
a plurality of pre-established classes of vehicles having first data relating to the use of first predetermined combinations of usage parameters of the component and second data relating to the use of second predetermined combinations of similar usage parameters of the vehicle for vehicles belonging to a same class, and
reference data associated with each class, the reference data being obtained from data on the course of said control parameter representative of wear of the component of each of the vehicles of the class considered,
the at least one calculator being configured to:
a. collect a data set of said vehicle comprising:
i. first data relating to the use of first predetermined combinations of usage parameters of said component,
ii. second data relating to the use of second predetermined combinations of usage parameters of said vehicle,
iii. third data for establishing the course of at least one control parameter of the component representative of wear of the component according to the number of kilometers traveled by the vehicle,
b. based on the first and second data of said vehicle, select, from the plurality of pre-established classes stored in the memory, a class for which the first data and the second data of said vehicle are similar to those of the vehicles of the class selected,
c. compare third data of the vehicle with the reference data of the class selected stored in the memory,
d. deduce, according to the result of the comparison, a future behavior of the component.

9. The device for predictive maintenance of at least one component (11) of a road vehicle (10) according to claim 8, wherein the calculator is configured to, at the end of the comparison, detect abnormal behavior of the component with respect to components of vehicles of the class selected and deduce a future failure of the component therefrom.

10. A computer program comprising instructions for implementing the method according to claim 1, when this program is executed by a processor.

11. A non-transitory computer-readable recording medium on which a program for implementing the method according to claim 1 is recorded, when this program is executed by a processor.
